(19) United States
(12) Patent Application Publication
(10) Pub. No.: US 2026/0343399 A1
(43) Pub. Date: Oct. 29, 2026

(54) METHOD, DEVICE AND COMPUTER STORAGE MEDIUM OF COMMUNICATION

(71) Applicant: NEC Corporation, Tokyo (JP)

(72) Inventors: Minghui XU, Beijing (CN); Gang WANG, Beijing (CN)

(73) Assignee: NEC Corporation, Tokyo (JP)

(21) Appl. No.: 19/121,492

(22) PCT Filed: Oct. 28, 2022
(86) PCT No.: PCT/CN2022/128450

§ 371 Date: Apr. 16, 2025

(51) Int. Cl. H04W 48/20; H04W 28/04; H04W 48/08; H04W 64/00

(52) U.S. Cl. CPC H04W 48/20; H04W 28/04; H04W 48/08; H04W 64/00

(57) ABSTRACT

Embodiments of the present disclosure relate to methods, devices and computer readable media for communication. A network device receives information of a set of NCRs associated with another network device. At least based on the information, the network device determines a measurement configuration for a terminal device. The network device transmits the measurement configuration to the terminal device. In this way, information of a NCR may be considered for RRM.

### TECHNICAL FIELD

Embodiments of the present disclosure generally relate to the field of telecommunication, and in particular, to methods, devices and computer storage media of communication for radio resource management (RRM) considering a network-controlled repeater (NCR).

### BACKGROUND

Recently, a NCR is introduced by adding side control information for beam management on a basis of a radio frequency (RF) repeater to extend coverage in a high frequency (HF) with a higher efficient method. However, when the NCR is introduced, RRM such as cell selection or cell reselection or interference management becomes more complex and needs to be enhanced.

### SUMMARY

In general, embodiments of the present disclosure provide methods, devices and computer storage media of communication for RRM considering a NCR.

In a first aspect, there is provided a method of communication. The method comprises: receiving, at a repeater device and from a first network device, a signaling indicating a cell selection irrespective of a connective state of the repeater device; performing, based on the signaling, the cell selection to access to a second network device; and transmitting information of the repeater device to the second network device.

In a second aspect, there is provided a method of communication. The method comprises: receiving, at a second network device, first information of a set of repeater devices associated with a first network device; determining a measurement configuration for a terminal device at least based on the first information; and transmitting the measurement configuration to the terminal device.

In a third aspect, there is provided a method of communication. The method comprises: receiving, at a terminal device and from a second network device, a measurement configuration determined based on at least first information of a set of repeater devices associated with a first network device.

In a fourth aspect, there is provided a method of communication. The method comprises: transmitting, at a first network device and to a repeater device, a signaling indicating a cell selection irrespective of a connective state of the repeater device.

In a fifth aspect, there is provided a device of communication. The device comprises a processor configured to cause the device to perform the method according to any of the first to fourth aspects of the present disclosure.

In a sixth aspect, there is provided a computer readable medium having instructions stored thereon. The instructions, when executed on at least one processor, cause the at least one processor to perform the method according to any of the first to fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication scenario in which some embodiments of the present disclosure can be implemented;

FIG. 1B illustrates an example communication model of a NCR in which some embodiments of the present disclosure can be implemented;

FIG. 2 illustrates a schematic diagram illustrating an example process of communication according to embodiments of the present disclosure;

FIG. 3 illustrates a schematic diagram illustrating another example process of communication according to embodiments of the present disclosure;

FIG. 4 illustrates an example method of communication implemented at a repeater device in accordance with some embodiments of the present disclosure;

FIG. 5 illustrates an example method of communication implemented at a network device in accordance with some embodiments of the present disclosure;

FIG. 6 illustrates an example method of communication implemented at a terminal device in accordance with some embodiments of the present disclosure;

FIG. 7 illustrates another example method of communication implemented at a network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “repeater device” may be interchangeably used with “repeater” or “network-control repeater”, and the term “beam” may be interchangeably used with “link” or “channel” or “spatial filter”. In the context of the present application, the term “side control information” may be interchangeably used with “control information” or “on-off information”. In the context of the present application, the term “synchronization signal and physical broadcast channel block (SSB) index” may be interchangeably used with “channel information-reference signal (CSI-RS) index”.

In the context of the present application, a slot may comprise 14 symbols if a cyclic prefix (CP) length is a normal CP, and a slot may comprise 12 symbols if a CP length is an extended cyclic prefix (ECP). For convenience, embodiments of the present disclosure are described in connection with a normal CP. It is to be understood that embodiments of the present disclosure may also be applied in connection with ECP.

As mentioned above, when a NCR is introduced, RRM such as cell selection or reselection or interference management becomes more complex and needs to be enhanced. For example, if UE is located at coverage of both a NCR and a gNB, the state of the NCR may influence a cell selection or reselection result, and may also influence interference management.

In view of this, embodiments of the present disclosure provide a solution of communication for RRM considering a NCR. In one aspect, a network device (for convenience, also referred to as a first network device herein) associated with a repeater device transmits, to the repeater device, a signaling indicating a cell selection irrespective of a connective state of the repeater device. The repeater device performs the cell selection to access to another network device (for convenience, also referred to as a second network device herein), and transmits information of the repeater device to the second network device. In this way, a cell selection of a repeater device may be triggered. In addition, the repeater device may temporarily access to a neighbor cell related to the second network device and transmit information of the repeater device to the neighbor cell.

In another aspect, a network device (i.e., the second network device) may receive information of a set of repeater devices associated with another network device (i.e., the first network device). Based on the information of the set of repeater devices, the network device determines a measurement configuration for a terminal device served by the network device, and transmits the measurement configuration to the terminal device. In this way, information of a NCR may be considered for RRM.

Principles and implementations of the present disclosure will be described in detail below with reference to the figures.

### Example of Communication Network

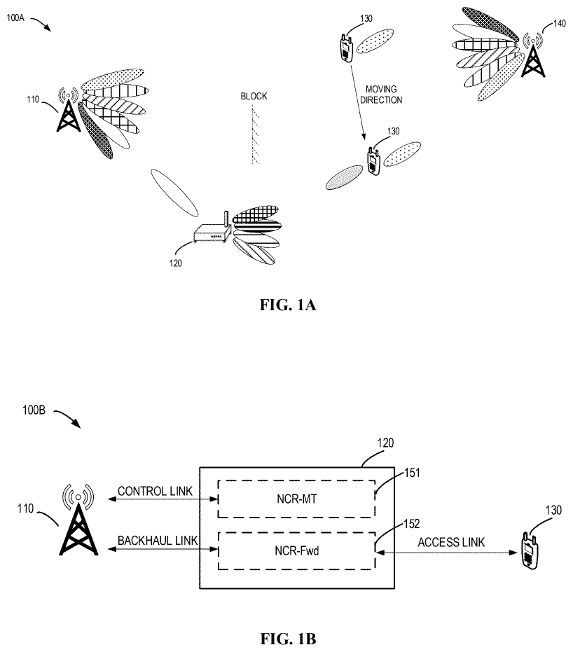

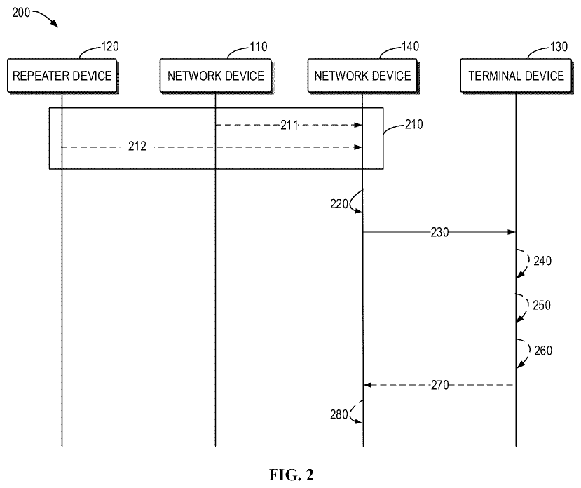

FIG. 1A illustrates a schematic diagram of an example communication network 100A in which embodiments of the present disclosure can be implemented. As shown in FIG. 1A, the communication network 100A may comprise a network device 110 and a repeater device 120 accessing to the network device 110. The communication network 100A may also comprise a terminal device 130 and a network device 140 serving the terminal device 130. Each of these devices may support a plurality of beams for communication.

In some scenarios, the network device 110 may communicate with a terminal device (not shown) via the repeater device 120. The repeater device 120 may have a forwarding function (also referred to as a normal operation mode) and a monitoring function (also referred to as a low power consumption mode). In the normal operation mode, the repeater device 120 may forward a signal transmission between the network device 110 and the terminal device. That is, the repeater device 120 may receive a signal from the network device 110, then amplify the received signal and forward the amplified signal to the terminal device. Or the repeater device 120 may receive a signal from the terminal device, then amplify the received signal and forward the amplified signal to the network device 110. In the low power consumption mode, the repeater device 120 may intermittently or periodically monitor a signal from the network device 110.

In some embodiments, the network device 110 may transmit side control information to the repeater device 120. The side control information may comprise at least one of the following: beamforming information, timing information to align transmission or reception boundaries of the repeater device 120, information on uplink (UL)-downlink (DL) time division duplexing (TDD) configuration, on-off information for efficient interference management and improved energy efficiency, or power control information for efficient interference management.

It is to be understood that the number of devices or beams in FIG. 1A is given for the purpose of illustration without suggesting any limitations to the present disclosure. The communication network 100A may involve any suitable number of network devices and/or repeater devices and/or terminal devices and/or beams adapted for implementing implementations of the present disclosure.

The communications in the communication network 100A may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

FIG. 1B illustrates an example communication model 100B of a NCR in which some embodiments of the present disclosure can be implemented. For convenience, this will be described with reference to the example of FIG. 1A. As shown in FIG. 1B, the NCR 120 may comprise a mobile termination element (denoted as NCR-MT) 151 and a forwarding element (denoted as NCR-Fwd) 152. The NCR-MT 151 may be defined as a function entity to communicate with the network device 110 via a control link to enable information exchange (e.g., side control information). The control link may be based on a Uu interface. The side control information may be at least used for the control of the NCR-Fwd 152. The NCR-Fwd 152 may defined as a function entity to perform the amplify-and-forwarding of UL/DL RF signal between the network device 110 and a terminal device (not shown) via a backhaul link and an access link. The behavior of the NCR-Fwd 152 will be controlled according to the received side control information from the network device 110.

Return to FIG. 1A, in some scenarios, as the terminal device 130 moves, the terminal device 130 may be located at coverage of both the network device 140 and the NCR 120. In this case, the state of the NCR 120 may influence a cell reselection result of the terminal device 130. On the other hand, the terminal device 130 may receive signals from both the network device 140 and the network device 110 via the NCR 120. In this case, the state of the NCR 120 may also influence interference management for the terminal device 130.

Embodiments of the present disclosure provide a solution of communication so as to achieve RRM considering a NCR. The solution will be described below with reference to FIG. 2.

### Example Implementation of RRM Considering NCR

FIG. 2 illustrates a schematic diagram illustrating an example process 200 of communication according to embodiments of the present disclosure. For the purpose of discussion, the process 200 will be described with reference to FIG. 1A. The process 200 may involve the network device 110, the repeater device 120, the terminal device 130 and the network device 140 as illustrated in FIG. 1A. It to be noted that the process 200 may comprise more additional steps or omit some steps shown, and the present disclosure does not limit the order of the steps.

As shown in FIG. 2, the network device 140 may receive 210 information (for convenience, also referred to as first information herein) of a set of repeater devices associated with the network device 110. In this example, only the repeater device 120 is associated with the network device 110. It is to be understood that the set of repeater devices may comprise one or more repeater devices. In some embodiments, the set of repeater devices comprises all the repeater devices associated with the network device 110. In some embodiments, the set of repeater devices comprises a part of the repeater devices associated with the network device 110.

In some embodiments, the first information may comprise an identity of a repeater device (e.g., each repeater device) in the set of repeater devices. In some embodiments, the first information may comprise a location of a repeater device (e.g., each repeater device) in the set of repeater devices. In some embodiments, the first information may comprise a coverage of a repeater device (e.g., each repeater device) in the set of repeater devices. In some embodiments, the first information may comprise a number of repeater devices in the set of repeater devices. Alternatively, a number of identities or locations of repeater devices may be taken as an implicit indication of the number of repeater devices. In some embodiments, the first information may comprise a number of beams of a repeater device (e.g., each repeater device) in the set of repeater devices. For example, the first information may comprise at least one of the number of beams for SSB transmission or forwarding of the repeater device, or the number of beams for CSI-RS transmission or forwarding of the repeater device. In some embodiments, the first information may comprise gain of beams of a repeater device (e.g., each repeater device) in the set of repeater devices. For example, the first information may comprise at least one of gain of beams for SSB transmission or forwarding of the repeater device, or gain of beams for CSI-RS transmission or forwarding of the repeater device. In some embodiment, when the forwarding module of the repeater device is OFF, then the gain of the repeater device is denoted by 0 in the first information, while the forwarding module of the repeater device is ON, the gain of the repeater device is denoted by 1 or another value in the first information. It is to be understood that the first information may comprise any combination of the above information and any other suitable information.

With reference to FIG. 2, in some embodiments, the network device 140 may receive 211, from the network device 110, the information of each repeater device in the set of repeater devices. For example, the information may be exchanged based on an information element (IE) Neighbour Information NR as shown in Table 1 below.

TABLE 1

| | | | IE type | Semantics |
|---|---|---|---|---|
| IE/Group Name | Presence | Range | and reference | description |
| Neighbour Information NR | | [symbol] | | |
| >NRPC [symbol] | [symbol] | | [symbol] | [symbol] |
| >NR CG [symbol] | [symbol] | | [symbol] | |
| >TAC | [symbol] | | [symbol] | [symbol] |
| >RANAC | O | | [symbol] | |
| >CHOICE NR-Mode-Info | [symbol] | | | |
| >> [symbol] DD | | | | |
| >>> [symbol] DD Info | | [symbol] | | |
| >>>> [symbol] NR FreqInfo | [symbol] | | [symbol] | [symbol] |
| >>>>DL NR FreqInfo | [symbol] | | [symbol] | |
| >>TDD | | | | |
| >>>TDD Info | | [symbol] | | |
| >>>>NR FreqInfo | [symbol] | | [symbol] | |
| >Connectivity Support | [symbol] | | [symbol] | |
| >Measurement Timing | [symbol] | | OCTET STRING | [symbol] |
| Configuration | | | | |
| >NCR | O | [symbol] | | [symbol] |
| >> [symbol] | | [symbol] | | [symbol] |
| >>gain of access beam | | | | [symbol] |
| >>location | | | | [symbol] |
| >>coverage range | | | | [symbol] |

[symbol]

indicates data missing or illegible when filed

It is to be understood that Table 1 is merely an example, and any other suitable forms are also feasible.

Alternatively, the network device 110 may report the information of the set of repeater devices to a core network element (e.g., operation administration and maintenance (OAM) or any other suitable entities) and the network device 140 may receive the information of the set of repeater devices from the core network element. For example, each gNB reports corresponding information of NCR to OAM, and OAM shares the information among gNBs.

In some embodiments, the network device 140 may receive 212 corresponding information from each repeater device (e.g., the repeater device 120) in the set of repeater devices. It is to be understood that the network device 140 may obtain the information of the set of repeater devices in any other suitable ways.

In some embodiments, the network device 140 may also receive information (for convenience, also referred to as second information herein) of the network device 110. For example, in some embodiments, the second information may comprise an identity of the network device 110. In some embodiments, the second information may comprise a frequency band of the network device 110. In some embodiments, the second information may comprise a location of the network device 110. It is to be understood that the second information may comprise any combination of the above information and any other suitable information.

In some embodiments, the second information may be received together with the first information. In some embodiments, the second information may be received separately from the first information. In some embodiments, the second information may be received from the network device 110. In some embodiments, the second information may be received from the repeater device 120. In some embodiments, the second information may be received from a core network element.

Continue to refer to FIG. 2, the network device 140 may determine 220 a measurement configuration for the terminal device 110 at least based on the first information. In some embodiments where the second information is also received, the network device 140 may determine the measurement configuration for the terminal device 110 based on the first and second information.

In some embodiments, the network device 140 may determine, based on the first information, a bitmap configuration for the terminal device 130 to measure SSB transmitted from both the network device 110 and the set of repeater devices (e.g., the repeater device 120). For example, if a beam of the repeater device 120 is in ON state or the beam gain of the repeater device 120 is larger than a predefined value, a corresponding bit in the bitmap configuration may be set to 1. If a beam of the repeater device 120 is in OFF state or the beam gain of the repeater device 120 is smaller than a predefined value, a corresponding bit in the bitmap configuration may be set to 0 or there is no bit related to the beam in the bitmap configuration.

In some embodiments, the network device 140 may define or use a bitmap field to reflect both beams of the network device 110 and beams of the set of repeater devices associated with the network device 110. In some embodiments, a length of the bitmap field may be determined by equation (1) below.

L=64+M*N (1)

where L denotes the length of the bitmap field, M denotes a maximum number of beams for a repeater device, and N denotes a maximum number of repeater devices associated with the network device 110. In some embodiments, whether to measure the beams of a set repeater devices are indicated via the rightest N*M bits.

For illustration, an example SSB measurement configuration may be configured as below. It can be seen that longBitmap2 with size of 80 is designed with N*M being equal to 16.

| [symbol] CHOICE [symbol] | |
|---|---|
| [symbol] | BIT STRING (SIZE [symbol] |
| [symbol] | BIT STRING (SIZE [symbol] |
| [symbol] | BIT STRING (SIZE [symbol] |
| [symbol] | BIT STRING (SIZE [symbol] |

[symbol]

[symbol]

indicates data missing or illegible when filed

In some alternative embodiments, the network device 140 may determine, based on the first information, a bitmap configuration (for convenience, also referred to as a first bitmap configuration herein) for the terminal device 140 to measure the SSB from the network device 110 and a bitmap configuration (for convenience, also referred to as a second bitmap configuration herein) for the terminal device 120 to measure the SSB measurements from the set of repeater devices (e.g., the repeater device 120). In some embodiments, the network device 140 may define or use an additional bitmap tie to the longBitmap/mediumBitmap to reflect the SSB forwarding beams of the set of repeater devices associated with the network device 110. For example, a number of sub bitmaps for the additional bitmap is M and a length of each sub bitmap is N*m, where m=1, 2, . . . , M, M denotes a maximum number of beams for a repeater device, and N denotes a maximum number of repeater devices associated with the network device 110. If the number of repeater devices with state “ON” is m, or the real number of repeater device is m, the sub bitmap with a length of m*N is chosen to define the measurement state for beams for the m repeater devices. M and N are different for mediumBitmap and longBitmap.

For illustration, an example SSB measurement configuration may be configured as below. It can be seen that addBitmap comprising bitMap 1 and bitMap 2 is added for mediumBitmap with both M and N are equal to 2, and addBitmap comprising bitMap 1, bitMap 2, bitMap 3 and bitMap 4 is added for longBitmap with both M and N are equal to 4.

| [symbol] CHOICE [symbol] | |
|---|---|
| [symbol] | BIT STRING (SIZE [symbol] |
| [symbol] | SEQUENCE [symbol] |
| [symbol] | BIT STRING (SIZE [symbol] |
| [symbol] | CHOICE [symbol] |
| [symbol] | BIT STRING (SIZE [symbol] |
| [symbol] | BIT STRING (SIZE [symbol] |

| | |
|---|---|
| [symbol] | OPTIONAL |

| | |
|---|---|
| [symbol] | SEQUENCE [symbol] |
| [symbol] | BIT STRING (SIZE [symbol] |
| [symbol] | CHOICE [symbol] |
| [symbol] | BIT STRING (SIZE [symbol] |
| [symbol] | BIT STRING (SIZE [symbol] |
| [symbol] | BIT STRING (SIZE [symbol] |
| [symbol] | BIT STRING (SIZE [symbol] |

| | |
|---|---|
| [symbol] | OPTIONAL |

[symbol]

[symbol]

indicates data missing or illegible when filed

In some embodiments, the network device 140 may also update a SSB measurement timing configuration (SMTC). In some embodiments, the network device 140 may update a periodicity, offset and duration to make sure that the updated SSBs related to the repeater device 120 to be measured are within the SMTC. In some embodiments, a value range of the duration may be extended with some half frame value. In this way, SSBs for the network device 110 and the set of repeater devices may be measured within the duration.

For illustration, an example SMTC configuration may be defined as below. It can be seen that an extended value range of the duration is defined.

[symbol]

SEQUENCE

[symbol]

| | |
|---|---|
| [symbol] | CHOICE [symbol] |
| [symbol] | INTEGER [symbol] |
| [symbol] | INTEGER [symbol] |
| [symbol] | INTEGER [symbol] |
| [symbol] | INTEGER [symbol] |
| [symbol] | INTEGER [symbol] |
| [symbol] | INTEGER [symbol] |

[symbol]

| | |
|---|---|
| duration | ENUMERATED [symbol] |

[symbol]

[symbol]

SEQUENCE

[symbol]

| | | |
|---|---|---|
| [symbol] | SEQUENCE (SIZE [symbol] OF PhysCellId | OPTIONAL, -- Need M |

| | |
|---|---|
| [symbol] | ENUMERATED ( [symbol] ) |

[symbol]

[symbol]

SEQUENCE

[symbol]

| | | |
|---|---|---|
| [symbol] | SEQUENCE (SIZE [symbol] OF PhysCellId | OPTIONAL, -- Need R |

| | |
|---|---|
| [symbol] | ENUMERATED ( [symbol] ) |

[symbol]

[symbol]

indicates data missing or illegible when filed

In some embodiments, the network device 140 may determine a configuration for interference measurements based on the first information. In some embodiments, if a frequency of ON-OFF or power or gain state switching of a repeater device is low, then an updated CSI-RS configuration may be used to update the related interference measurement for the terminal device 140, to make sure that the measured CSI is matched with a real channel. If the frequency of ON-OFF or power or gain state switching of state switching of the repeater device is too high to track via updating the CSI-RS configuration, the configuration for interference measurements may indicate a set of types associated with a number of repeater devices that cause interference to the terminal device 110. For example, multiple types may be defined for a configured CSI-RS set, and each type may be mapped to one kind of state of a repeater device. For example, Type1 may denote that no NCR is “ON”. Type2 may denote that one NCR introduces interference to the terminal device 130. Type3 may denote that two NCRs introduce interference to the terminal device 130. It is to be noted that these are merely examples, more or less types may also be feasible. Whether a NCR will introduce interference to the terminal device can be determined by the location of the NCR, the location of the network devices 110 and 140, or even the location of the terminal device 130.

Continue to refer to FIG. 2, upon determination of the measurement configuration, the network device 140 may transmit 230 the measurement configuration to the terminal device 130. In some embodiments, the measurement configuration may comprise a set of configurations for interference measurements. Configurations in the set of configurations are associated with different types in a set of types, a type in the set of types indicating a number of repeater devices that cause interference to the terminal device 110.

In some embodiments, upon reception of the bitmap configuration, the terminal device 130 may perform 240 SSB measurements for cell selection or reselection based on the measurement configuration.

In some embodiments, upon reception of the set of configurations for interference measurements, the terminal device 130 may obtain 250, based on a configuration in the set of configurations, a candidate set of results of the interference measurements in different time within a predetermined duration. The terminal device 130 may determine 260 a result (for convenience, also referred to as a first result herein) of the interference measurements based on the candidate set of results of the interference measurements, and the result is associated with a type (for convenience, also referred to as a first type herein) in the set of types. In other words, only measurement results from the same type may be used to filter. Results of same type from different time within a pre-defined duration are used to determine a final result for reporting.

The terminal device 130 may transmit 270 the first result with the first type to the network device 140. In this way, the network device 140 may receive, from the terminal device 130, a set of results of the interference measurements, a result in the set of results associated with a type in the set of types. The network device 140 may determine 280 a scheduling for the terminal device 130 based on a result in the set of results associated with a selected type in the set of types. In other words, the network device 140 may determine the scheduling based on a result of one type from all the types. In this way, benefits of interference measurements may be improved.

With the process 200, based on exchange of information of a repeater device among cells, a terminal device located within each cell may measure the cell and the neighbor cells more effective with limited signaling overhead, and an optimized RRM may be achieved.

Embodiments of the present disclosure also provide a solution of a cell selection of a repeater device. The solution may be applied to transmission of the information of the repeater device. In the solution, a dedicated signaling for cell selection is designed for a repeater device and a network device associated with the repeater device.

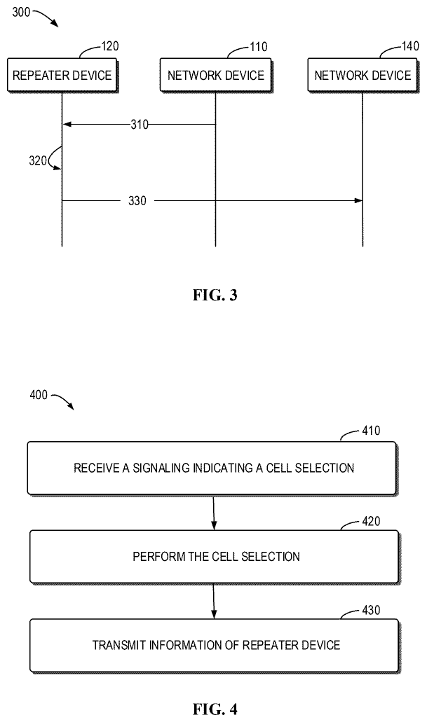

It is assumed that a default serving cell may be defined based on network planning results and/or location information. The default serving cell index may be configured for a stable NCR or NCR-MT. If no addition indication is received, NCR may be accessed to the default cell. A dedicated signaling is defined for NCR to reselect a cell temporarily. When NCR-MT receives the dedicated signaling, a cell reselection procedure for NCR or NCR-MT may be started. The details will be described below in connection with FIG. 3.

FIG. 3 illustrates a schematic diagram illustrating an example process 300 of communication according to embodiments of the present disclosure. For the purpose of discussion, the process 300 will be described with reference to FIG. 1A. The process 300 may involve the network device 110, the repeater device 120 and the network device 140 as illustrated in FIG. 1A. It to be noted that the process 300 may comprise more additional steps or omit some steps shown, and the present disclosure does not limit the order of the steps.

As shown in FIG. 3, the network device 110 may transmit 310, to the repeater device 120, a signaling indicating a cell selection irrespective of a connective state of the repeater device 120. The connective state of the repeater device 120 comprises RRC_CONNECTED, RRC_INACTIVE or RRC_ILDE state.

In some embodiments, the signaling may comprise neighbor cell information of the network device 140. For example, the neighbor cell information may comprise normal information for cell selection or reselection, e.g., frequency information of a neighbor cell, subcarrier spacing (SCS) of a neighbor cell, normal priority information of a neighbor cell or any combination of the above information. It is to be understood that any other suitable information are also feasible.

In some embodiments, the signaling may comprise an additional priority of a neighbor cell associated with a location of the neighbor cell and a location of the repeater device 120. In some embodiments, the priority of the neighbor cell may also be associated with a location of the serving cell. In some embodiments, the smaller the range between a neighbor cell and a repeater device is, the higher the additional priority is. The larger the range between a neighbor cell and a repeater device is, the lower the additional priority is.

In some embodiments, the signaling may comprise a white list of neighbor cells available for the cell selection. In some embodiments, the signaling may comprise a black list of neighbor cells unavailable for the cell selection.

In some embodiments, the network device 110 may initially determine the white or black list of neighbor cells or the normal or additional priorities of neighbor cells based on some known information. The repeater device 120 may perform measurements on the neighbor cells in order based on the initially determined white or black list or priorities of neighbor cells and report results of the measurements to the network device 110. Based on results of measurements reported by a set of repeater device of the network device 110, the network device 110 may update the initially determined white or black list or normal or additional priorities of neighbor cells.

It is to be understood that the signaling may comprise any combination of the above information and any other suitable information.

Continue to refer to FIG. 3, upon reception of the signaling, the repeater device 120 may perform 320 the cell selection to access to the network device 140. In some embodiments, the repeater device 120 may determine a candidate set of neighbor cells based on at least one of the white list or black list, and measure a first neighbor cell with a first additional priority among the candidate set of neighbor cells. For example, the repeater device 120 may measure a neighbor cell with a highest additional priority among the candidate set of neighbor cells. It is to be understood that other higher priorities may also be feasible.

If quality of the first neighbor cell satisfies a predetermined criterion in a period of time, the repeater device 120 may access to the first neighbor cell. If the quality of the first neighbor cell does not satisfy the predetermined criterion in the period of time, the repeater device 120 may measure a second neighbor cell with a second additional priority in the candidate set of neighbor cells, the second additional priority being lower than the first additional priority. For example, the repeater device 120 may measure a neighbor cell with a second highest additional priority among the candidate set of neighbor cells. It is to be understood that other lower additional priorities may also be feasible. That is, a neighbor cell with the highest additional priority is measured first and a neighbor cell with the lowest additional priority is measured last. The predetermined criterion may be carried out in any suitable ways.

In some embodiments, the cell selection may be operated via NCR-MT. In some embodiments, the cell selection may be enabled even if the NCR-MT is in a RRC_CONNECTED state. In some embodiments, an indication transmitted from a network device to NCR-MT may be used to indicate switching the state of the NCR-MT from a RRC_CONNECTED state to a RRC_INACTIVE or RRC_IDLE state.

After accessing to the network device 140, the repeater device 120 may transmit 330 information of the repeater device 120 to the network device 140. In some embodiments, the information may comprise at least one of the following: an identity of the repeater device 120; a location of the repeater device 120; a coverage of the repeater device 120; a number of beams of the repeater device 120; or gain of beams of the repeater device 120. In some embodiments, the gain of beams may comprise the ON-OFF state of the repeater device 120. For example, when the forwarding module of the repeater device is OFF, the gain of the repeater device is denoted by 0 in the gain information, while the forwarding module of the repeater device is ON, the gain of the repeater device is denoted by 1 or another value in the gain information.

In some embodiments, after reporting the information to the network device 140, the repeater device 120 may measure and access to the next neighbor cell to report the information.

In some embodiments, if a neighbor cell does not satisfy the predetermined criterion in the period of time, the neighbor cell doesn't expect to receive the information of the repeater device 120.

In some embodiments, if a neighbor cell does not satisfy the predetermined criterion in the period of time, the information of the repeater device 120 may be exchanged to the network device 140 via the network device 110.

In this way, a cell selection of a NCR is achieved. Although the process 300 is described in connection with transmission of the information of NCR, a procedure of the cell selection of NCR the process 300 may also be applied to other suitable scenarios. In some embodiments, NCR may locate at an edge of coverage of at least two gNBs. One gNB may be defined as a local gNB based on network planning for each NCR, and the others may be defined as supplementary gNBs. If there is no traffic requiring a NCR for the local gNB, the NCR may be scheduled by the supplementary gNBs. In these embodiments, comparing with the process 300, same information is needed for the NCR to access to the supplementary gNBs, and same additional priority is defined for the NCR to access to the supplementary gNBs. The cell reselection procedure is different from the temporary cell reselection for report of the information of NCR.

It is to be understood that the solutions described in the processes 200 and 300 may be used separately or in any suitable combination.

In some embodiments, before information of the set of repeater devices transmitted from the network device 110 to the network device 140, measurement results for neighbor cells may be reported by the set of repeater devices. Based on the measurement results, the network device 110 may determine information of which repeater device in the set of the repeater devices is to be transmitted to the network device 140. For example, a threshold of reference signal receiving power (RSRP) may be pre-defined or pre-configured when the measurement results are RSRPs.

### Example Implementation of Methods

Accordingly, embodiments of the present disclosure provide methods of communication implemented at a network device, a repeater device and a terminal device. These methods will be described below with reference to FIGS. 4 to 7.

FIG. 4 illustrates an example method 400 of communication implemented at a repeater device in accordance with some embodiments of the present disclosure. For example, the method 400 may be performed at the repeater device 120 as shown in FIG. 1A. For the purpose of discussion, in the following, the method 400 will be described in connection with FIG. 1A. It is to be understood that the method 400 may include additional blocks not shown and/or may omit some blocks as shown, and the scope of the present disclosure is not limited in this regard.

At block 410, the repeater device 120 receives, from a first network device (e.g., the network device 110), a signaling indicating a cell selection irrespective of a connective state of the repeater device 120.

In some embodiments, the signaling comprises at least one of the following: neighbor cell information of the first network device; a priority of a neighbor cell associated with a location of the neighbor cell and a location of the repeater device; a white list of neighbor cells available for the cell selection; or a black list of neighbor cells unavailable for the cell selection.

At block 420, the repeater device 120 performs, based on the signaling, the cell selection to access to a second network device (e.g., the network device 140).

In some embodiments, the repeater device 120 may determine a candidate set of neighbor cells based on at least one of the white list or black list, and measure a first neighbor cell with a first priority among the candidate set of neighbor cells. If quality of the first neighbor cell satisfies a predetermined criterion in a period of time, the repeater device 120 may access to the first neighbor cell.

In some embodiments, if the quality of the first neighbor cell does not satisfy the predetermined criterion in the period of time, the repeater device 120 may measure a second neighbor cell with a second priority in the candidate set of neighbor cells, the second priority being lower than the first priority.

At block 430, the repeater device 120 transmits information of the repeater device 120 to the second network device.

In some embodiments, the information comprises at least one of the following: an identity of the repeater device; a location of the repeater device; a coverage of the repeater device; a number of beams of the repeater device; or gain of the beams of the repeater device.

With the method 400, information of a NCR may be reported to a non-serving cell.

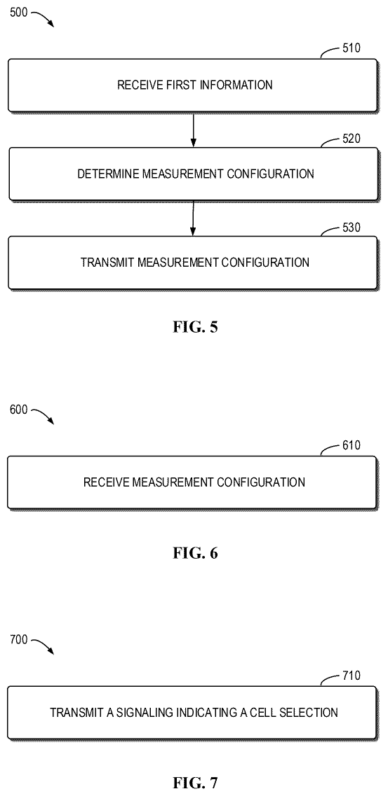

FIG. 5 illustrates an example method 500 of communication implemented at a network device in accordance with some embodiments of the present disclosure. For example, the method 500 may be performed at the network device 140 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, a second network device (e.g., the network device 140) receives first information of a set of repeater devices associated with a first network device (e.g., the network device 110).

In some embodiments, the first information comprises at least one of the following: an identity of a repeater device in the set of repeater devices; a location of a repeater device in the set of repeater devices; a coverage of a repeater device in the set of repeater devices; a number of repeater devices in the set of repeater devices; a number of beams of a repeater device in the set of repeater devices; or gain of beams of a repeater device in the set of repeater devices.

In some embodiments, the second network device may receive the first information from the set of repeater devices. In some embodiments, the second network device may receive the first information from the first network device. In some embodiments, the second network device may receive the first information from a core network element.

At block 520, the second network device determines a measurement configuration for the terminal device 130 at least based on the first information.

In some embodiments, the second network device may determine, based on the first information, a bitmap configuration for synchronization signal and physical broadcast channel block, SSB, measurements for both the first network device and the set of repeater devices. In some embodiments, the second network device may determine, based on the first information, a first bitmap configuration for SSB measurements for the first network device and a second bitmap configuration for SSB measurements for the set of repeater devices.

In some embodiments, the second network device may determine a configuration for interference measurements, the configuration indicating a set of types associated with a number of repeater devices that cause interference to the terminal device 130.

At block 530, the second network device transmits the measurement configuration to the terminal device 130.

In some embodiments, the second network device may further receive, from the first network device or a core network element, second information of the first network device. In these embodiments, the second network device may determine the measurement configuration at least based on the first and second information.

In some embodiments, the second information comprises at least one of the following: an identity of the first network device; a location of the first network device; or a frequency band of the first network device.

In some embodiments where a configuration for interference measurements is transmitted, the second network device may further receive, from the terminal device 130, a set of results of the interference measurements, a result in the set of results associated with a type in the set of types; and determine a scheduling for the terminal device based on a result in the set of results associated with a selected type in the set of types.

With the method 500, a measurement configuration may be updated based on information of a NCR.

FIG. 6 illustrates an example method 600 of communication implemented at a terminal device in accordance with some embodiments of the present disclosure. For example, the method 600 may be performed at the terminal device 130 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, a terminal device (e.g. the terminal device 130) receives, from a second network device (e.g., the network device 140), a measurement configuration determined based on at least first information of a set of repeater devices associated with a first network device (e.g., the network device 110).

In some embodiments, the first information comprises at least one of the following: an identity of a repeater device in the set of repeater devices; a location of a repeater device in the set of repeater devices; a coverage of a repeater device in the set of repeater devices;
a number of repeater devices in the set of repeater devices; a number of beams of a repeater device in the set of repeater devices; or gain of beams of a repeater device in the set of repeater devices.

In some embodiments, the measurement configuration may comprise a bitmap configuration for SSB measurements for both the first network device and the set of repeater devices. In some embodiments, the measurement configuration may comprise a first bitmap configuration for SSB measurements for the first network device and a second bitmap configuration for SSB measurements for the set of repeater devices.

In some embodiments, the measurement configuration may comprise a set of configurations for interference measurements, configurations in the set of configurations being associated with different types in a set of types, a type in the set of types indicating a number of repeater devices that cause interference to the terminal device. In these embodiments, the terminal device 130 may obtain, based on a configuration in the set of configurations, a candidate set of results of the interference measurements in different time within a predetermined duration and determine a first result of the interference measurements based on the candidate set of results of the interference measurements, the first result being associated with a first type in the set of types. The terminal device 130 may transmit the first result with the first type to the second network device.

With the method 600, signal measurements may be optimized.

FIG. 7 illustrates another example method 700 of communication implemented at a network device in accordance with some embodiments of the present disclosure. For example, the method 700 may be performed at the network device 110 as shown in FIG. 1A. For the purpose of discussion, in the following, the method 700 will be described in connection with FIG. 1A. It is to be understood that the method 700 may include additional blocks not shown and/or may omit some blocks as shown, and the scope of the present disclosure is not limited in this regard.

At block 710, a first network device (e.g., the network device 110) transmits, to a repeater device (e.g., the repeater device 120), a signaling indicating a cell selection irrespective of a connective state of the repeater device 120.

In some embodiments, the signaling comprises at least one of the following: neighbor cell information of the first network device; a priority of a neighbor cell associated with a location of the neighbor cell and a location of the repeater device; a white list of neighbor cells available for the cell selection; or a black list of neighbor cells unavailable for the cell selection.

With the method 700, a cell selection of a NCR may be triggered.

### Example Implementation of Device and Apparatus

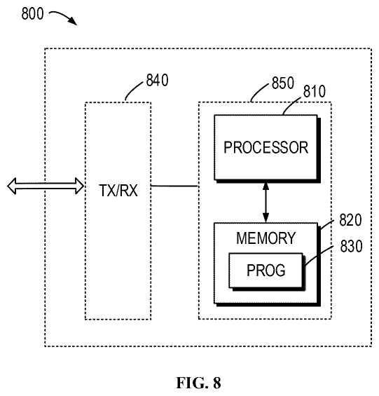

FIG. 8 is a simplified block diagram of a device 800 that is suitable for implementing embodiments of the present disclosure. The device 800 can be considered as a further example implementation of the network device 110 or the repeater device 120 or the terminal device 130 or the network device 140 as shown in FIG. 1A. Accordingly, the device 800 can be implemented at or as at least a part of the network device 110 or the repeater device 120 or the terminal device 130 or the network device 140.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1A to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a repeater device comprises a circuitry configured to: receive, from a first network device, a signaling indicating a cell selection irrespective of a connective state of the repeater device; perform, based on the signaling, the cell selection to access to a second network device; and transmit information of the repeater device to the second network device.

In some embodiments, a second network device comprises a circuitry configured to: receive first information of a set of repeater devices associated with a first network device; determine a measurement configuration for a terminal device at least based on the first information; and transmit the measurement configuration to the terminal device.

In some embodiments, a terminal device comprises a circuitry configured to: receive, from a second network device, a measurement configuration determined based on at least first information of a set of repeater devices associated with a first network device.

In some embodiments, a first network device comprises a circuitry configured to: transmit, to a repeater device, a signaling indicating a cell selection irrespective of a connective state of the repeater device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: receiving, at a repeater device and from a first network device, a signaling indicating a cell selection irrespective of a connective state of the repeater device; performing, based on the signaling, the cell selection to access to a second network device; and transmitting information of the repeater device to the second network device.

In some embodiments, the information comprises at least one of the following: an identity of the repeater device; a location of the repeater device; a coverage of the repeater device; a number of beams of the repeater device; or gain of the beams of the repeater device.

In some embodiments, the signaling comprises at least one of the following: neighbor cell information of the first network device; a priority of a neighbor cell associated with a location of the neighbor cell and a location of the repeater device; a white list of neighbor cells available for the cell selection; or a black list of neighbor cells unavailable for the cell selection.

In some embodiments, performing the cell selection comprises: determining a candidate set of neighbor cells based on at least one of the white list or black list; measuring a first neighbor cell with a first priority among the candidate set of neighbor cells; and in accordance with a determination that quality of the first neighbor cell satisfies a predetermined criterion in a period of time, accessing to the first neighbor cell.

In some embodiments, the method above further comprises: in accordance with a determination that quality of the first neighbor cell does not satisfy the predetermined criterion in the period of time, measuring a second neighbor cell with a second priority in the candidate set of neighbor cells, the second priority being lower than the first priority.

In another solution, a method of communication comprises: receiving, at a second network device, first information of a set of repeater devices associated with a first network device; determining a measurement configuration for a terminal device at least based on the first information; and transmitting the measurement configuration to the terminal device.

In some embodiments, the first information comprises at least one of the following: an identity of a repeater device in the set of repeater devices; a location of a repeater device in the set of repeater devices; a coverage of a repeater device in the set of repeater devices; a number of repeater devices in the set of repeater devices; a number of beams of a repeater device in the set of repeater devices; or gain of beams of a repeater device in the set of repeater devices.

In some embodiments, receiving the first information comprises: receiving the first information from the set of repeater devices; receiving the first information from the first network device; or receiving the first information from a core network element.

In some embodiments, the method further comprises: receiving, from the first network device or a core network element, second information of the first network device. In these embodiments, determining the measurement configuration comprises determining the measurement configuration at least based on the first and second information.

In some embodiments, the second information comprises at least one of the following: an identity of the first network device; a location of the first network device; or a frequency band of the first network device.

In some embodiments, determining the measurement configuration comprises: determining, based on the first information, a bitmap configuration for synchronization signal and physical broadcast channel block, SSB, measurements for both the first network device and the set of repeater devices; or determining, based on the first information, a first bitmap configuration for SSB measurements for the first network device and a second bitmap configuration for SSB measurements for the set of repeater devices.

In some embodiments, determining the measurement configuration comprises: determining a configuration for interference measurements, the configuration indicating a set of types associated with a number of repeater devices that cause interference to the terminal device.

In some embodiments, the method above further comprises: receiving, from the terminal device, a set of results of the interference measurements, a result in the set of results associated with a type in the set of types; and determining a scheduling for the terminal device based on a result in the set of results associated with a selected type in the set of types.

In another solution, a method of communication comprises: receiving, at a terminal device and from a second network device, a measurement configuration determined based on at least first information of a set of repeater devices associated with a first network device.

In some embodiments, the first information comprises at least one of the following: an identity of a repeater device in the set of repeater devices; a location of a repeater device in the set of repeater devices; a coverage of a repeater device in the set of repeater devices; a number of repeater devices in the set of repeater devices; a number of beams of a repeater device in the set of repeater devices; or gain of beams of a repeater device in the set of repeater devices.

In some embodiments, the measurement configuration comprises: a bitmap configuration for synchronization signal and physical broadcast channel block, SSB, measurements for both the first network device and the set of repeater devices; or a first bitmap configuration for SSB measurements for the first network device and a second bitmap configuration for SSB measurements for the set of repeater devices.

In some embodiments, the measurement configuration comprises: a set of configurations for interference measurements, configurations in the set of configurations being associated with different types in a set of types, a type in the set of types indicating a number of repeater devices that cause interference to the terminal device. In these embodiments, the method further comprises: obtaining, based on a configuration in the set of configurations, a candidate set of results of the interference measurements in different time within a predetermined duration; determining a first result of the interference measurements based on the candidate set of results of the interference measurements, the first result being associated with a first type in the set of types; and transmitting the first result with the first type to the second network device.

In another solution, a method of communication comprises: transmitting, at a first network device and to a repeater device, a signaling indicating a cell selection irrespective of a connective state of the repeater device.

In some embodiments, the signaling comprises at least one of the following: neighbor cell information of the first network device; a priority of a neighbor cell associated with a location of the neighbor cell and a location of the repeater device; a white list of neighbor cells available for the cell selection; or a black list of neighbor cells unavailable for the cell selection.

In another solution, a device of communication comprises: a processor configured to cause the device to perform the method according to any of claims above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a repeater device and from a first network device, a signaling indicating a cell selection irrespective of a connective state of the repeater device;
performing, based on the signaling, the cell selection to access to a second network device; and
transmitting information of the repeater device to the second network device.

2. The method of claim 1, wherein the information comprises at least one of the following:
an identity of the repeater device;
a location of the repeater device;
a coverage of the repeater device;
a number of beams of the repeater device; or
gain of the beams of the repeater device.

3. The method of claim 1, wherein the signaling comprises at least one of the following:
neighbor cell information of the first network device;
a priority of a neighbor cell associated with a location of the neighbor cell and a location of the repeater device;
a white list of neighbor cells available for the cell selection; or
a black list of neighbor cells unavailable for the cell selection.

4. The method of claim 3, wherein performing the cell selection comprises:
determining a candidate set of neighbor cells based on at least one of the white list or black list;
measuring a first neighbor cell with a first priority among the candidate set of neighbor cells; and
in accordance with a determination that quality of the first neighbor cell satisfies a predetermined criterion in a period of time, accessing to the first neighbor cell.

5. The method of claim 4, further comprising:
in accordance with a determination that quality of the first neighbor cell does not satisfy the predetermined criterion in the period of time, measuring a second neighbor cell with a second priority in the candidate set of neighbor cells, the second priority being lower than the first priority.

6. A method of communication, comprising:
receiving, at a second network device, first information of a set of repeater devices associated with a first network device;
determining a measurement configuration for a terminal device at least based on the first information; and
transmitting the measurement configuration to the terminal device.

7. The method of claim 6, wherein the first information comprises at least one of the following:
an identity of a repeater device in the set of repeater devices;
a location of a repeater device in the set of repeater devices;
a coverage of a repeater device in the set of repeater devices;
a number of repeater devices in the set of repeater devices;
a number of beams of a repeater device in the set of repeater devices; or
gain of beams of a repeater device in the set of repeater devices.

8. The method of claim 6, wherein receiving the first information comprises:
receiving the first information from the set of repeater devices;
receiving the first information from the first network device; or
receiving the first information from a core network element.

9. The method of claim 6, wherein the method further comprises: receiving, from the first network device or a core network element, second information of the first network device, and
wherein determining the measurement configuration comprises: determining the measurement configuration at least based on the first and second information.

10. The method of claim 9, wherein the second information comprises at least one of the following:
an identity of the first network device;
a location of the first network device; or
a frequency band of the first network device.

11. The method of claim 6, wherein determining the measurement configuration comprises:
determining, based on the first information, a bitmap configuration for synchronization signal and physical broadcast channel block, SSB, measurements for both the first network device and the set of repeater devices; or
determining, based on the first information, a first bitmap configuration for SSB measurements for the first network device and a second bitmap configuration for SSB measurements for the set of repeater devices.

12. The method of claim 6, wherein determining the measurement configuration comprises:
determining a configuration for interference measurements, the configuration indicating a set of types associated with a number of repeater devices that cause interference to the terminal device.

13. The method of claim 12, further comprising:
receiving, from the terminal device, a set of results of the interference measurements, a result in the set of results associated with a type in the set of types; and
determining a scheduling for the terminal device based on a result in the set of results associated with a selected type in the set of types.

14. A method of communication, comprising:
receiving, at a terminal device and from a second network device, a measurement configuration determined based on at least first information of a set of repeater devices associated with a first network device.

15. The method of claim 14, wherein the first information comprises at least one of the following:
an identity of a repeater device in the set of repeater devices;
a location of a repeater device in the set of repeater devices;
a coverage of a repeater device in the set of repeater devices;
a number of repeater devices in the set of repeater devices;
a number of beams of a repeater device in the set of repeater devices; or
gain of beams of a repeater device in the set of repeater devices.

16. The method of claim 14, wherein the measurement configuration comprises:
a bitmap configuration for synchronization signal and physical broadcast channel block, SSB, measurements for both the first network device and the set of repeater devices; or
a first bitmap configuration for SSB measurements for the first network device and a second bitmap configuration for SSB measurements for the set of repeater devices.

17. The method of claim 14, wherein the measurement configuration comprises:
a set of configurations for interference measurements, configurations in the set of configurations being associated with different types in a set of types, a type in the set of types indicating a number of repeater devices that cause interference to the terminal device.

18. The method of claim 17, further comprising:
obtaining, based on a configuration in the set of configurations, a candidate set of results of the interference measurements in different time within a predetermined duration;
determining a first result of the interference measurements based on the candidate set of results of the interference measurements, the first result being associated with a first type in the set of types; and
transmitting the first result with the first type to the second network device.
